(19) United States
(12) Patent Application Publication
(10) Pub. No.: US 2016/0040558 A1
(43) Pub. Date: Feb. 11, 2016

(54) THERMAL POWER PLANT WITH A STEAM TURBINE

(71) Applicant: Siemens Aktiengesellschaft, Munich (DE)

(72) Inventors: Gunter Bauer, Herzogenaurach (DE); Uwe Lenk, Zwickau (DE); Alexander Tremel, Erlangen (DE)

(73) Assignee: Siemens Aktiengesellschaft, Munich (DE)

(21) Appl. No.: 14/817,287

(22) Filed: Aug. 4, 2015

(30) Foreign Application Priority Data
Aug. 7, 2014 (DE) 102014215672.6

(51) Int. Cl. F01K 13/02; F02C 6/04; F01K 23/00

(52) U.S. Cl. CPC F01K 13/02; F01K 23/00; F02C 6/04

(57) ABSTRACT

A thermal power plant has a primary heat supply, a steam generator, a steam turbine and an auxiliary gas turbine, wherein the primary heat supply is fluidically connected to the steam generator, wherein the auxiliary gas turbine is fluidically connected to the steam generator and is set up to keep the steam generator at a predefined minimum temperature when the primary heat supply is off-line, wherein a fan is encompassed, which fan is fluidically connected to the steam generator. A method is for the variable-power operation of such a thermal power plant, wherein the auxiliary gas turbine is brought on-line in dependence on an operating state of the primary heat supply, which is defined by the power to be provided by the latter.

### CROSS REFERENCE TO RELATED APPLICATIONS

This application claims the benefit of German Application No. DE 102014215672.6 filed 7 Aug 2014, incorporated by reference herein in its entirety.

### FIELD OF INVENTION

The invention relates to a thermal power plant which comprises a primary heat supply, a steam generator and a steam turbine, wherein the primary heat supply is fluidically connected to the steam generator. The invention further relates to a method for the variable-power operation of a thermal power plant.

### BACKGROUND OF INVENTION

The reliable operation of a large-area electrical grid presents particular challenges to conventional power plants by means of which the grid is supplied with energy—in particular as renewable energy generation gains ground. Meanwhile, in many countries, state regulations mean that energy generated in a renewable manner enjoys preferential feed-in into the respective grid. The power which can be fed into the grid by means of renewable energy generation is naturally subject to substantial variation. This leads, on the side of the grid operator, to the necessity of being able to even out these variations in power via conventional power plants which are as flexible as possible, and to block power peaks as required.

One concept which has become established in this regard is that of the combined cycle power plant. A combined cycle power plant generally consists of one or more gas turbines which, in a first step, generate mechanical energy by burning natural gas, which mechanical energy is accordingly converted into electrical energy in a generator. The waste heat which is contained in the flue gas from the combustion is used in a second step to operate a steam turbine by means of a steam generator. The mechanical energy generated there by means of the steam produced using the flue gas waste heat is also converted into electrical energy in a generator.

The use of a gas turbine in the first step has the advantage, over power plants using other fossil fuels such as coal or crude oil, or over nuclear power, of a partially substantially shorter start-up time. This flexibility leads to more rapid availability of the energy to be provided in the grid. Using the waste heat contained in the flue gas of the gas turbine for operating the steam turbine also substantially increases the efficiency of the plant. Whereas a pure gas turbine usually converts into electrical energy approximately 40% of the energy content of the fuel used, this figure is as high as 60% in a combined cycle power plant.

However, combining the gas turbine with a steam turbine, which is desirable in order to increase efficiency, imposes certain conditions on operation: If a combined cycle power plant is taken off-line because of lack of demand for the power in the grid, this leads to the components of the plant cooling down, wherein the rate of cooling depends on the thermal capacity of the components. However, the steam circuit should be at a minimum temperature for operation of the steam turbine. The components of the steam circuit of the steam turbine, in particular of the steam generator, should therefore be protected from cooling as much as possible since the more the plant cools down the longer the heating-up process takes, and thus the possibility of making the full power of the plant available. Furthermore, repeated cooling and heating of the components of the steam generator should be avoided since in both of these cases thermomechanical stresses can arise which, long-term, reduce the service life of the plant.

Since a combined cycle power plant is not to be kept hot over a long period without the gas turbine being in operation, there is a possibility of avoiding the steam generator cooling down, in that, when power in the grid is not in demand, the gas turbine is operated at only minimum power, and to that end, where relevant, the generators of the steam turbine and possibly also the gas turbine are removed from the grid. However, this is not advantageous for reasons of long-term efficiency. An alternative consists in an auxiliary, externally fired steam generator which keeps the steam circuit and in particular the steam generator at a desired temperature while the gas turbine is off-line. Such a steam heater must however be integrated into the steam circuit, which in particular makes retro-fitting existing plants substantially more difficult.

A further approach for solving the cooling problem can be found in for example DE 10 2012 223 818 A1, according to which a second, smaller gas turbine is to be provided as an auxiliary unit whose flue gas heat can be used to keep the steam generator hot. However, in this context it is disadvantageous that the volume flow rate of the auxiliary unit can vary and, most particularly, at low volume flow rates there results an uneven distribution of the flue gas in the steam generator. This can result in the formation of regions of the steam generator which are at different temperatures while the system is kept hot. The consequence of this is in turn an increased start-up time since this time is determined by the temperatures of the coldest regions in the steam generator.

### SUMMARY OF INVENTION

The invention is therefore based on an object of indicating a thermal power plant with a steam turbine in which the steam generator of the steam turbine can be kept hot as energy-efficiently and as evenly as possible when little or no electrical power is to be produced by the thermal power plant. This is in particular to be brought about in a controlled manner such that the variations of different temperatures in the steam generator are as slight as possible while the system is kept hot. The invention is further based on an object of indicating a method for the variable-power operation of such a thermal power plant.

The first object is achieved according to the invention with a thermal power plant, comprising a primary heat supply, a steam generator, a steam turbine and an auxiliary gas turbine, wherein the primary heat supply is fluidically connected to the steam generator, wherein the auxiliary gas turbine is fluidically connected to the steam generator and is set up to keep the steam generator at a predefined minimum temperature when the primary heat supply is off-line, wherein a fan is encompassed, which fan is fluidically connected to the steam generator.

The second object is achieved according to the invention with a method for the variable-power operation of an above-described thermal power plant, wherein the auxiliary gas turbine is brought on-line in dependence on an operating state of the primary heat supply, which is defined by the power to be provided by the latter.

The power provided by the heat supply is to be understood in this context as, in particular, the heat power which can be used in the thermal power plant for generating electrical power.

In particular, in this context, when the thermal power plant is in operation, the primary heat supply generates thermal energy from a fossil fuel in a combustion process. The thermal energy produced can in this context be used directly for heating the steam generator, via which the steam turbine is operated, as is the case for example in a coal-fired power plant. For generating electrical power when the thermal power plant is in operation, in this context the steam turbine is in particular mechanically coupled to a generator. In particular, the primary heat supply can first also drive a primary thermal engine, for example a gas turbine, whose waste heat heats the steam generator. In particular, the steam generator can in this context also be additionally heated, for example by means of a further combustion process using a fossil fuel. Such a primary thermal engine can in this context be mechanically coupled to a generator for the production of electrical power.

A predefined minimum temperature is in this case to be established in particular by thermomechanical conditions in the steam generator, and can in particular also vary over the internal space of the steam generator. In particular, in that context, the minimum temperature is substantially greater than the ambient temperature, in particular close to the local temperature reached in each case when the steam turbine is in operation.

In this context, the invention is based on the following considerations:

Most efficient possible operation of a thermal power plant of the type described requires on one hand that the operation be adapted, where possible, to demand for power in the grid. Depending on the load on the grid, this can also mean that the thermal power plant is advantageously to be removed from the grid. In such a case, it would be advantageous for operation to shut down altogether. However, this would lead to the thermal power plant cooling down. However, on account of the high operating pressures which arise, there are built into the steam circuit of a thermal power plant of the above-described type, and in this context in particular into the steam generator, components which are often made of solid, thick metal sheets and accordingly are subjected to mechanical stresses in the event of temperature changes. For that reason, temperature changes in the steam generator are to be avoided as much as possible in an operating state in which, due to grid conditions, the primary heat supply is to be shut down.

However, since for both thermodynamic and fluid dynamic reasons a primary heat supply often requires a certain minimum quantity of fuel per unit time in order to maintain its operation, it is now provided to provide the quantity of heat required for maintaining the predefined minimum temperature in the steam generator via an auxiliary gas turbine.

A surprising point in this context is that the auxiliary gas turbine can be given compact dimensions such that it is also possible to retro-fit existing plants. This is in particular possible because the waste heat to be produced by the auxiliary gas turbine merely has to keep the steam generator at a minimum temperature which is as close as possible to the operating temperature, and does not—contrary to the primary heat supply—have to provide any further heat for the operation of the steam generator, and can therefore also accordingly be made more compact than the primary heat supply.

In particular, the auxiliary gas turbine can in this context also be brought on-line in an operating state in which the power to be provided by the thermal power plant to the grid is below its nominal minimum power. The power can be generated by means of the auxiliary gas turbine and a generator coupled thereto, while the primary heat supply can be taken off-line.

In particular, in this context the auxiliary gas turbine is also taken off-line in dependence on an operating state of the primary heat supply. In particular, for the definition of the operating state, the power to be provided by the primary heat supply is determined in dependence on the electrical power to be generated by the thermal power plant.

According to the invention, the thermal power plant also comprises a fan which is fluidically connected to the steam generator. The fan can in this context blow additional air into the steam generator via the fluidic connection. This is of use if the volume flow rate of the flue gas of the auxiliary gas turbine is significantly less than the volume flow rate of the flue gas of a primary thermal engine. The fan can thus be used to prevent an uneven distribution of the flue gas of the auxiliary gas turbine in the steam generator, which uneven distribution could lead there to undesirable local temperature gradients. In particular, it is possible in this context to make the hot flue gas of the auxiliary gas turbine (hot gas) flow via a duct into the steam generator, which is structurally separated from the fan. The fan can additionally also be set up to recirculate flue gas of the auxiliary gas turbine, which has already passed through the steam generator and has an accordingly lower temperature (cold gas), into the steam generator.

In particular, the primary heat supply takes the form of a primary thermal engine, in particular of at least one gas turbine. In particular, the primary thermal engine can also consist of a multiplicity of gas turbines. A combined cycle power plant is often used in a grid for the flexible provision of peak power and to even out variations in power which arise as a consequence of the uneven provision of power by renewable energy production. If the grid is already at full load, the combined cycle power plant cannot feed in any further power. Its operation is therefore advantageous to be separated from the grid. In this context, the procedure of using an auxiliary gas turbine to keep the steam generator at a predefined minimum temperature, while the or every gas turbine is off-line, allows particularly energy-efficient operation.

It has proven to be advantageous if the maximum electrical power which can be generated using the auxiliary gas turbine is up to 10%, in particular up to 5%, of the electrical power of the thermal power plant. The electrical power is in this context advantageously generated using a generator which is mechanically coupled to the auxiliary gas turbine. An auxiliary gas turbine with such a power range is suitable, in operation, for producing sufficient waste heat to keep the steam generator at the predefined minimum temperature, and still permits a compact construction. This is particularly welcome with a view to retro-fitting an existing thermal power plant.

According to a further embodiment of the invention, the fan is connected to the steam generator via a flow duct, wherein the fluidic connection between the auxiliary gas turbine and the steam generator passes via the flow duct. This leads to the air and/or cold gas volume flow rate produced by the fan being already enriched with the hot gas upon reaching the steam generator, which permits a particularly homogeneous temperature distribution of the hot gas-air/cold gas volume flow rate.

Advantageously, for operation, the fan is electrically coupled to the auxiliary gas turbine. In that context, the electrical coupling is in particular effected via a generator mechanically coupled to the auxiliary gas turbine. Thus, the electrical energy required for operating the fan is directly provided by the auxiliary gas turbine, such that it is no longer necessary to connect the fan to the grid, such that the method for keeping the steam generator hot can be carried out independently of the state of the grid.

It is further advantageous if for operation the fan is mechanically coupled to the auxiliary gas turbine. The coupling can, in that context, be effected for example via the shaft of the gas turbine, wherein if appropriate a gearing can also be connected between the two. In addition, a mechanical coupling to the gas turbine makes it possible to keep the steam generator hot independently of the grid.

Expediently, the auxiliary gas turbine has a sealing flap to fluidically separate it—when required—from the steam generator. It is thus possible to prevent, in normal operation of the primary heat supply and simultaneous stoppage of the auxiliary gas turbine, an undesirable penetration of the flue gas of the primary heat supply into the auxiliary gas turbine.

In a further advantageous embodiment of the method, the auxiliary gas turbine is brought on-line in an operating state in which the primary heat supply provides a power close to its maximum power, in particular above 90% of its maximum power, more particularly above 95% of its maximum power, in particular also its maximum power. It is thus possible, in the case of increased power demand in the grid, for the thermal power plant to further increase its available maximum power by the electrical power which can be generated using the auxiliary gas turbine, via a generator coupled to the latter. On account of the high flexibility of the auxiliary gas turbine, this leads to improved stability of the grid.

In an alternative embodiment of the method, in an operating state in which the primary heat supply is taken off-line, the operation of the auxiliary gas turbine keeps the steam generator at a predefined minimum temperature. This prevents, on one hand, thermomechanical stresses which can arise in the steam generator during cooling, which increases the service life of the components. On the other hand, it is thus possible, in the event of a stoppage, for the steam turbine to be brought back on-line more quickly, since the steam generator remains closer to the operating temperature, such that the maximum power of the thermal power plant is available more quickly.

In particular, the steam generator in this context generates steam, with the steam turbine being kept at a predefined minimum temperature by means of the steam. It is thus also possible to prevent thermomechanical stresses, which can arise in the steam circuit in the event of excessive cooling outside the steam generator. This has a positive effect on the service life and the necessary maintenance cycles of the thermal power plant.

Expediently, electrical power for operating at least one component of the thermal power plant is generated using the auxiliary gas turbine. A component can in this context be a compressor and/or a pump, as well as a control system and/or a management system. In particular, it can also be a fan. On one hand, this makes it possible to carry out the method independently of the grid. On the other hand, the thermal power plant can resume operation of the primary heat supply and of the steam turbine independently of the grid which, in the event of a complete power outage, leads to quicker provision of power and thus to quicker normalization of the entire grid operation.

### BRIEF DESCRIPTION OF THE DRAWINGS

There follows a more detailed explanation of an exemplary embodiment of the invention, with reference to a drawing, in which, schematically:

FIG. 1 shows the fluidic set-up of a combined cycle power plant with an auxiliary gas turbine and a fan, and

FIG. 2 shows the sequence of the method for operating the thermal power plant from FIG. 1.

### DETAILED DESCRIPTION OF INVENTION

Mutually corresponding parts and variables are in each case provided with identical reference signs in all figures.

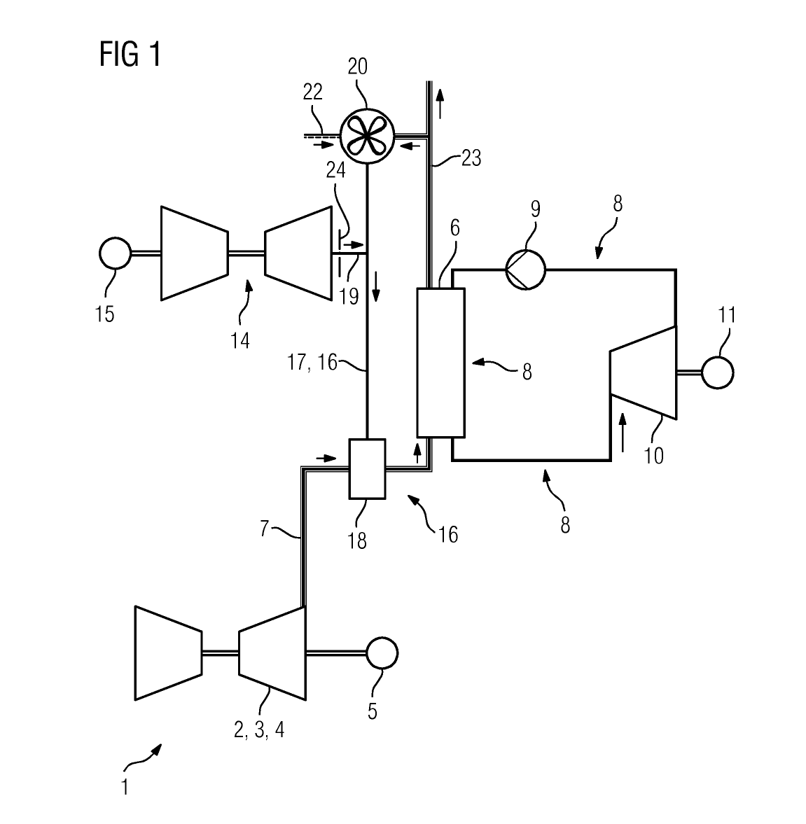

FIG. 1 shows, schematically, the set-up of a thermal power plant 1. In that context, the thermal power plant 1 comprises, as primary heat supply 2, a primary thermal engine 3 which takes the form of a gas turbine 4 and is mechanically coupled to a first generator 5. The gas turbine 4 is connected, on the flue gas side, to a steam generator 6. When the thermal power plant 1 is in operation, the steam generator generates steam using the waste heat contained in the flue gas 7 of the gas turbine 4, which steam is used, via the steam circuit 8 by means of a pump 9, for operation of the steam turbine 10. The steam turbine 10 is mechanically coupled to a second generator 11. The mode of operation of the steam generator 6 will be known to a person skilled in the art and will not be described in more detail here.

If for example the grid into which the thermal power plant 1 feeds its power is now already at full load, the generators 5, 11 should be removed from the grid. In such a case, in the exemplary embodiment, the gas turbine 4 and the steam turbine 10 will now also be shut down. Since this results in a drop in the flue gas which supplies the steam generator 6 with the heat necessary for operating the steam turbine 10, the steam generator 6 will now gradually cool down. In that context, the lower the temperature to which the steam generator 6 cools prior to the gas turbine 4 being brought back on-line, the longer it takes, in the case of resumption of operation of the steam turbine 10, until the steam circuit 8 has once again reached its optimum operating state with respect to pressure and temperature, and hence permits full power capacity of the steam turbine 10.

In order to prevent this cooling-down of the steam generator 6 and/or of the steam circuit 8, there is now provided in the thermal power plant 1 an auxiliary gas turbine 14 which is mechanically coupled to a third generator 15. The maximum electrical power which can be generated using the auxiliary gas turbine 14 is in this case 5-10% of the maximum electrical power of the thermal power plant 1.

The auxiliary gas turbine 14 has, on the flue gas side, a fluidic connection 16 to the steam generator 6. This fluidic connection 16 passes in this context through a flow duct 17 and via an inflow cap 18, via which the flue gas 7 of the gas turbine 4 is also guided to the steam generator 6. If the gas turbine 4 is taken off-line, the hot flue gas 19 (hot gas) of the auxiliary gas turbine 14 can protect the steam generator 6 from undesirable cooling. In this context, in order to ensure a sufficiently high volume flow rate in the steam generator 6, a fan 20 is also provided. Since the auxiliary gas turbine 14 has a markedly lower flue gas volume flow rate than the gas turbine 4, as a consequence of its comparatively smaller power range, the hot gas 19 from the fan 20 together with ambient air 22 and recirculated flue gas 23 which has already passed through the steam generator 6 (cold gas) is blown into the steam generator via the flow duct 17. A further portion of the flue gas 23 leaves the steam generator 6 without being recirculated via the fan 20. This prevents an uneven distribution of the hot gas 19 in the steam generator 6. The operational power for the fan 20 is provided by means of the third generator 15.

Moreover, during such a stoppage of the gas turbine 4 and of the steam turbine 10, the third generator 15 can also drive the pump 9 in the steam circuit 8, such that the heat given off by the hot gas 19 of the auxiliary gas turbine 14 to the steam generator 6 can be distributed over the entire steam circuit 8. It is thus possible for the entire steam circuit 8 to be kept close to the operating temperature, which makes it easier still to re-start the steam turbine 10. In order to prevent, during operation of the gas turbine 4, flue gas 7 of the gas turbine 4 entering the auxiliary gas turbine 14 via the common inflow cap 18 and the flow duct 17, the auxiliary gas turbine 14 has, on the flue gas side, a sealing flap 24 which is designed to close when the auxiliary gas turbine 14 is not in operation.

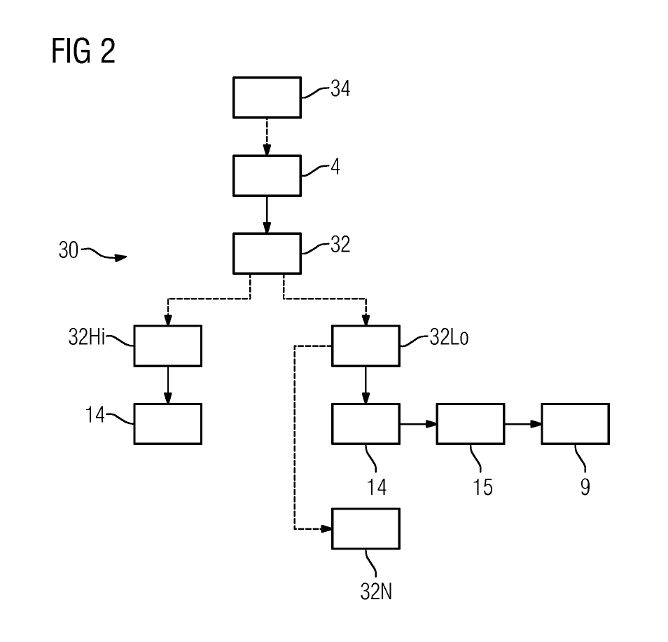

FIG. 2 shows, schematically, a method 30 for the variable-power operation of a thermal power plant 1 as shown in FIG. 1. First, an operating state 32 of the gas turbine 4 is determined in dependence on the power to be provided by the latter to the grid 34.

Thus, for example, the grid 34 might demand the maximum possible power from the thermal power plant 1, and there still remains unused capacity in the grid 34. As a result, in such an operating state 32Hi the gas turbine 4 also has to provide the maximum possible power. In this case, the auxiliary gas turbine 14 is brought on-line in order to make full use of the remaining free capacity in the grid 34.

In the event that the grid 34 is already at full capacity without the thermal power plant 1 being in operation, the result of this is that the gas turbine 4 also has to provide as little power as possible, which is to be fed into the grid. In such an operating state 32Lo, the gas turbine 4 is taken off-line and the auxiliary gas turbine 14 is brought on-line in order to keep the steam generator 6 close to the operating temperature. The electrical power which is generated in that context by means of the auxiliary gas turbine 14 and the third generator 15 can be used in this context to use a pump 9 to keep steam moving in the steam circuit 8, such that the heat of the auxiliary gas turbine 14 spreads from the steam generator 6 to the entire steam circuit 8. This prevents the steam generator 6 and the steam circuit 8 from cooling down, which because of thermomechanical stresses would have a negative effect on the service life of the components.

If the thermal power plant 1 is now required to feed a substantial contribution of power, for example 60-80% of its maximum power, into the grid 34, in such an operating state 32N the normal operation of the gas turbine 4 is resumed and the auxiliary gas turbine 14 is shut down. By virtue of the fact that, during the operating state 32Lo the steam in the steam generator 8 was kept close to the operating temperature, the steam turbine 10 can provide the required power more quickly. The thermal power plant 1 operates more efficiently overall.

Although the invention has been described and illustrated in greater detail by means of the preferred exemplary embodiment, the invention is not limited by this exemplary embodiment. Other variants can be derived herefrom by a person skilled in the art without departing from the protective scope of the invention.

1. A thermal power plant, comprising
a primary heat supply, a steam generator, a steam turbine and an auxiliary gas turbine,
wherein the primary heat supply is fluidically connected to the steam generator,
wherein the auxiliary gas turbine is fluidically connected to the steam generator and is set up to keep the steam generator at a predefined minimum temperature when the primary heat supply is off-line, and
a fan is encompassed, which fan is fluidically connected to the steam generator.

2. The thermal power plant as claimed in claim 1,
wherein the primary heat supply takes the form of a primary thermal engine.

3. The thermal power plant as claimed in claim 1,
wherein the maximum electrical power which can be generated using the auxiliary gas turbine is up to 10% of the electrical power of the thermal power plant.

4. The thermal power plant as claimed in claim 1,
wherein the fan is connected to the steam generator via a flow duct, and
wherein the fluidic connection between the auxiliary gas turbine and the steam generator passes via the flow duct.

5. The thermal power plant as claimed in claim 1,
wherein for operation the fan is electrically coupled to the auxiliary gas turbine.

6. The thermal power plant as claimed in claim 1,
wherein for operation the is mechanically coupled to the auxiliary gas turbine.

7. The thermal power plant as claimed in claim 1,
wherein the auxiliary gas turbine has a sealing flap to fluidically separate it when required from the steam generator.

8. A method for the variable-power operation of a thermal power plant as claimed in claim 1,
wherein the auxiliary gas turbine is brought on-line in dependence on an operating state of the primary heat supply, which is defined by the power to be provided by the latter primary heat supply.

9. The method as claimed in claim 8,
wherein the auxiliary gas turbine is brought on-line in a high operating state in which the primary heat supply provides a power close to its maximum power.

10. The method as claimed in claim 8,
wherein, in low operating state in which the primary heat supply is taken off-line, the operation of the auxiliary gas turbine keeps the steam generator at a predefined minimum temperature.

11. The method as claimed in claim 10,
wherein the steam generator generates steam, and
wherein the steam turbine is kept at a predefined minimum temperature by the steam.

12. The method as claimed in claim 10,
wherein electrical power for operating at least one component of the thermal power plant is generated using the auxiliary gas turbine.

13. The thermal power plant as claimed in claim 1,
wherein the primary heat supply takes the form of a primary thermal engine of at least one gas turbine.

14. The thermal power plant as claimed in claim 1,
wherein the maximum electrical power which can be generated using the auxiliary gas turbine is up to 5% of the electrical power of the thermal power plant.
